(19) United States
(12) Patent Application Publication
(10) Pub. No.: US 2005/0135376 A1
(43) Pub. Date: Jun. 23, 2005

(54) Media gateway and method of managing local channel thereof

(76) Inventors: Hyun Joo Bae, Daejeon-city (KR); Seung Han Choi, Daejeon-city (KR); Tae Gyu Kang, Daejeon-city (KR); Do Young Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/910,500

(22) Filed: Aug. 2, 2004

(30) Foreign Application Priority Data
Dec. 23, 2003 (KR) 2003-95385

(51) Int. Cl. H04L 12/56

(52) U.S. Cl. 370/395.2; 370/437

(57) ABSTRACT

A media gateway and a method of managing a local channel thereof are provided. A main control processor selects one of at least one DSP in response to a call setup request and selects a TDM channel of the selected DSP. Then, the main control processor assigns a session number to the selected DSP in order to distinguish the call inside the selected DSP, and assigns a channel that is in an idle status among predetermined RTP available channels as an RTP channel for the call. The session number with respect to the TDM channel is assigned by the main control processor to the DSP if the main control processor selects the TDM channel of the DSP among a plurality of DSPs, each of which includes a plurality of TDM channels. The DSP stores the session number. A T-switch dynamically connects the plurality of TDM channels with a plurality of E1 links. The local DSPs of the media gateway can operate with only channel information necessary for the DSPs themselves without storing system-level channel information.

This application claims the priority of Korean Patent Application No. 2003-95385, filed on Dec. 23, 2003, in the Korean Intellectual Property Office, the disclosure of which is incorporated herein in its entirety by reference.

### BACKGROUND OF THE INVENTION

1. Field of the Invention

The present invention relates to a media gateway and a method of managing a local channel thereof, and more particularly, to a media gateway and a method of managing a local channel thereof which interfaces a public switched telephone network (PSTN) and voice over Internet protocol (VoIP).

2. Description of the Related Art

As network infrastructure technologies that support the Internet become more advanced and Internet networks become more widespread, data transmission/reception between remote locations can be achieved at increasingly lower cost. VoIP makes it possible to provide user-to-user voice call service over the Internet, because a VoIP network provides an infrastructure and an infrastructure protocol that enable transmission of voice data over an IP network.

IP network service charges are relatively low. Thus, by using VoIP, expensive international telephone charges can be saved. In order to interface a PSTN and VoIP, devices that convert different call control protocols and voice control protocols suitably for respective networks are needed. Among such devices, a media gateway converts voice control protocol.

As an interface unit for a PSTN and a VoIP network, a gateway that converts the call control protocol and the voice control protocol at the same time has been used. A media gateway manages media channels under the control of a media gateway controller through a media gateway control protocol, i.e., media gateway control (MEGACO) or media gateway control protocol (MGCP).

As one example of a call processing method using a conventional gateway, a VoIP gateway management method is disclosed in Korean Patent Publication No. 2003-0035404. The disclosed VoIP gateway management method enables rapid telephone calling without any waiting period after opening a voice channel. A destination gateway checks whether or not an H.245 address is contained in a call setup message that is provided from a source gateway. If it is found that an H.245 address is contained, the destination gateway makes an H.245 TCP connection and sends an H.245 message to the source gateway. Then, the destination gateway sends a call connection message to the source gateway.

Another example of a call processing method using a conventional gateway, more specifically, a VoIP call processing apparatus and method, is disclosed in Korean Patent Publication No. 2003-0052759. This reference discloses a gateway and a call setup method that are applicable to various PBXs relatively without being influenced by an operating system of PBX system, a call setup, a communication protocol of voice signal, and a variation of an embedded voice data processing unit, in a case where the gateway is embedded into PBX in which a call control signal and a voice data transmission/reception channel are separated from each other. The call processing apparatus includes a call control unit, a media data processing unit, and a system utility. The call control unit converts call control signals, which are generated in a PSTN-IP heterogeneous network, into signals suitable for opposite networks, and then transmits the converted signals. Also, the call control unit controls call processing resource management and media transmission/reception channels according to the call setup. The media data processing unit performs processes such as conversion and compression of voice data into data suitable for opposite networks. The system utility manages system resources, such as memory and a timer.

### SUMMARY OF THE INVENTION

The present invention provides a media gateway and a method of managing a channel thereof, in which the media gateway provides VoIP service through an interface of a PSTN network and an IP network and local channels of DSPs are operated independently through centralized channel management.

According to an aspect of the present invention, there is provided a media gateway, which includes: a main control processor which selects one of at least one DSP (digital signal processor) in response to a call setup request, selects a TDM (time division multiplexing) channel of the selected DSP, assigns a session number to the selected DSP in order to distinguish the call inside the selected DSP, and assigns a channel that is in an idle status among predetermined RTP (realtime transport protocol) available channels as an RTP channel for the call; a DSP to which the session number with respect to the TDM channel is assigned by the main control processor if the main control processor selects the TDM channel of the DSP among a plurality of DSPs each including a plurality of TDM channels, the DSP storing the session number; and a T-switch which dynamically connects the plurality of TDM channels with a plurality of E1 links.

According to another aspect of the present invention, there is provided a method of managing a channel in a media gateway, which includes: selecting one of at least one DSP in response to a call setup request, selecting a TDM channel of the selected DSP, and assigning a session number to the selected DSP in order to distinguish the call inside the selected DSP; assigning a channel that is in an idle status among predetermined RTP available channels as an RTP channel for the call; and connecting the assigned TDM channel and the assigned RTP channel.

The local DSPs of the media gateway can operate with only channel information necessary for the DSPs themselves without storing system-level channel information.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a media gateway that performs channel management according to the present invention;

FIG. 2 illustrates a channel management data structure of the media gateway according to the present invention;

FIG. 3 is a flowchart illustrating a method of managing a local channel during call processing in the media gateway according to the present invention;

FIG. 4 is a flowchart illustrating another method of managing a local channel during call processing in the media gateway according to the present invention; and

FIG. 5 is a flowchart illustrating a method of managing a channel in the media gateway according to the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

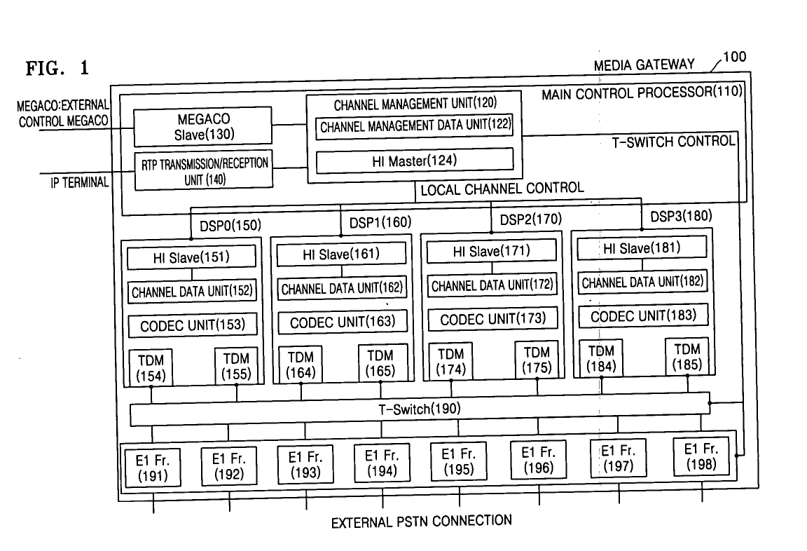

FIG. 1 illustrates a configuration of a media gateway that performs channel management according to the present invention.

Referring to FIG. 1, media gateway 100 according to the present invention includes a main control processor 110, a plurality of digital signal processors (DSPs) 150, 160, 170 and 180, a T-switch 190, and E1 framers 191 to 198. The main control processor 110 includes a channel management unit 120, a MEGACO slave 130, and a RTP transmission/reception unit 140. Also, the channel management unit 120 includes a channel management data unit 122 and a host interface (HI) master 124. At least one or more DSPs 150, 160, 170 and 180 are provided. The DSPs 150, 160, 170 and 180 include HI slaves 151, 161, 171 and 181, channel data units 152, 162, 172 and 182, codec units 153, 163, 173 and 183, and a plurality of TDMs 154 and 155, 164 and 165, 174 and 175, 184 and 185, respectively. Here, TDM indicates time division multiplexing.

In the media gateway 100 of the present invention, the main control processor 110 and the DSPs 150, 160, 170 and 180 operate in master/slave status. The main control processor 110 and the DSPs 150, 160, 170 and 180 perform communication as a host interface using the HI master 124 and the HI slaves 151, 161, 171 and 181. The host interface is an interface for data transmission/reception between main control processor (host processor) and a sub processor.

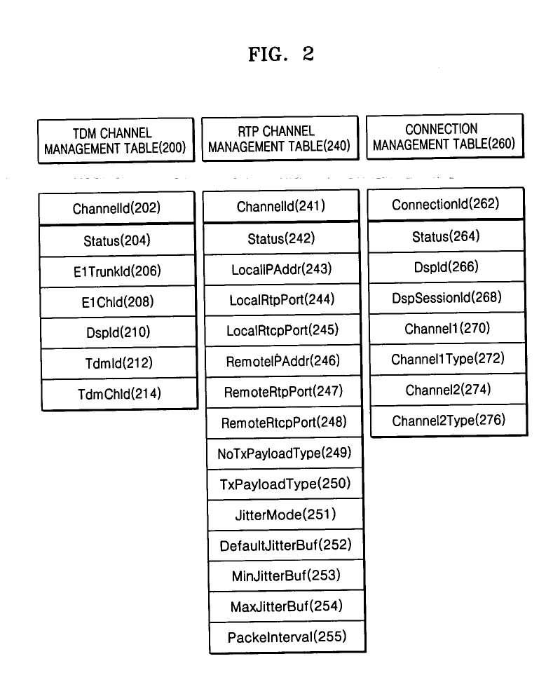

The channel management data unit 122 of the channel management unit 120 stores data used for managing internal resources (channels (TDM, E1, RTP, etc.), codec, switch) of the media gateway 100. The channel management data structure stored in the channel management data unit 122 will be described in detail later with reference to FIG. 2. The RTP transmission/reception unit 140 transmits/receives VoIP voice data from users during a call. The RTP transmission/reception unit 140 is installed in the main control processor 110 as software and manages transmission/reception of voice data.

The DSPs 150, 160, 170 and 180 include the codec units 153, 163, 173 and 183 which perform encoding/decoding of VoIP voice data. The TDMs 154 and 155, 164 and 165, 174 and 175, 184 and 185 which are PSTN interface, the HI slaves 151, 161, 171 and 181 which manage communication with the channel management unit 120 of the main control processor, and the channel data units 152, 162, 172 and 182 which store data (session number for distinguishing calls within the DSP, etc) related to the local channels of the DSPs.

The T-switch 190 dynamically connects the TDMs 154 and 155, 164 and 165, 174 and 175, 184 and 185 of the DSPs 150, 160, 170 and 180 with the E1 framers 191 to 198. The E1 framers 191 to 198 are directly connected with a PSTN exchange through E1 trunk.

The MEGACO slave 130 receives MEGACO protocol messages with predetermined commands from an external media gateway controller (MGC) through a media gateway control protocol (MGCP). The MEGACO slave 130 interprets the commands contained in the received MEGACO protocol messages and sends the interpreted commands to the channel management unit 120.

The commands contained in the MEGACO protocol messages include a channel assignment, a channel data modification, a channel connection, a channel disconnection, and the like. If the channel management unit 120 receives a command from the MEGACO slave 130, the channel management unit 120 performs an operation corresponding to the command.

Specifically, if the received command is the channel assignment, the channel management unit 120 assigns a local channel and maps the assigned local channel into an external channel. Then, the channel management unit 120 stores assigned local channel information and mapping information in the channel management data unit 122.

The local channel is a channel for mapping internal resources of the media gateway 100 independently of the external channel. For example, if only one DSP is present inside the media gateway, the channel number requested by the MGC can be used as is. Meanwhile, if two or more DSPs are present, it must be determined which DSP's channel numbers will be used among channel numbers 1 to 60 of the DSP1, channel numbers 1 to 60 of the DSP2 and channel numbers 1 to 60 of a DSP#N. Accordingly, the channel management unit 120 determines which channel number of which DSP among the plurality of DSPs will be assigned as the local channel. The external channel is a channel over which the media gateway 100 communicates with an external device.

If the received command is the channel data modification, the channel management unit 120 modifies the channel management data for the corresponding local channel. Also, if the received command is the channel connection, the channel management unit 120 selects one of the DSPs 150, 160, 170 and 180 using a DSP selection algorithm and selects the TDMs 154 and 155, 164 and 165, 174 and 175, 184 and 185 of the selected DSP using a TDM selection algorithm. In other words, the channel management unit 120 selects an available channel among the local channels of the selected DSP as the local channel, which will be mapped with the external channel, and then registers the selected local channel in the channel management data unit 122 of the channel management unit 120.

The channel management unit 120 uses the DSP selection algorithm and the TDM selection algorithm. The DSP selection algorithm selects a DSP by comparing performance weight data and DSP load. The performance weight data is data that is applied when programs for codec operate inside the DSP, and the DSP load is calculated by the number of codec processing according to DSP. The TDM selection algorithm selects a TDM having a small number of active TDM channels. The channel management unit 120 can also use other DSP selection algorithms and TDM selection algorithms.

The channel management unit 120 sends data related to TDM channels of the selected DSP to the channel data unit of the selected DSP. The channel management unit 120 sends data to the DSP through the HI master 124.

In call processing, the E1 framers 191 to 198 for external E1 link connection are dynamically connected with the DSPs 150, 160, 170 and 180 through the T-switch 190. If a media connection for a call that is requested through the MEGACO slave 130 is completed, voice data is transmitted/received between PSTN telephones connected to the E1 framers 191 to 198 and IP terminals connected to the RTP transmission/reception unit 140.

In other words, PSTN voice data is input through the E1 framers 191 to 198, the T-switch 190, and the TDMs 154 and 155, 164 and 165, 174 and 175, 184 and 185 of the selected DSP, to the codec units 153, 163, 173 and 183, which are internal voice data modulators of the DSPs. The PSTN data is converted into a realtime transport protocol (RTP) Payload suitable for the IP network in the codec units 153, 163, 173 and 183. Then, the RTP Payload is transmitted to the RTP transmission/reception unit 140 through HI slaves 151, 161, 171 and 181 and the HI master 124. Reversely, data from the IP terminal is transmitted through the HI master 124 of the channel management unit 120 and the HI slaves 151, 161, 171 and 181 of the DSP, and is converted into voice data suitable for the PSTN network by DSP internal voice data modulation. Then, the voice data is transmitted to the PSTN network.

FIG. 2 illustrates the channel management data structure of the media gateway according to the present invention.

Referring to FIG. 2, the channel management data unit 122 of the channel management unit in FIG. 1 includes a TDM channel management table 200, a RTP channel management table 240, and a connection management table 260.

The TDM channel management table 200 stores data necessary for connection of a PSTN terminal in the media gateway 100. If the channel. management unit 120 receives a TDM channel assignment request from the MEGACO slave 130, the channel management unit 120 selects a DSP and assigns an available TDM channel of the selected DSP in order for mapping to the external channel. Then, the channel management unit 120 stores data of the assigned channel in the TDM channel management table 200.

Specifically, ChannellD 202 is an identifier that the channel management unit 120 calculates based on TDM channel assignment request data (E1 link number, channel number) and that distinguishes the assigned TDM channels. Status 204 indicates a status of the assigned local channel and maintains the channel status during a call.

E1TrunkID 206 is an identifier that distinguishes the E1 trunk according to the TDM channel assignment request of the MEGACO slave 130. E1ChID 208 is an identifier that distinguishes the local channel of the E1 trunk. DspID 210, TdmID 212 and TdmChID 214 respectively store identification data about the DSPs 150, 160, 170 and 180, the TDMs 154 and 155, 164 and 165, 174 and 175, 184 and 185, and the TDM local channels, which are decided by the channel management unit 120 according to the TDM channel assignment request of the MEGACO salve 130. Referring to data of the TDM channel management table 200, the channel management unit 120 manages the DSP local channels and the E1 framer channels, which are necessary for VoIP processing.

The RTP channel management table 240 stores data necessary for connection with the IP terminal in the media gateway 100. If the channel management unit 120 receives the RTP channel assignment request from the MEGACO slave 130, the channel management unit 120 assigns an RTP channel and stores information on the assigned RTP channel in the RTP channel management table 240.

In detail, ChannelID 241 stores an identifier of an available RTP channel, which is found from Status 242 of the RTP channel after the channel management unit 120 receives the RTP channel assignment request from the MEGACO slave 130. The Status 242 indicates a current status of the RTP channel and status information is changed if the channel management unit 120 assigns the ChannelID 241 to the available RTP channel.

If the channel management unit 120 receives the channel data modification request from the MEGACO slave 130, the channel management unit 120 modifies the remaining fields 243 to 255 of the RTP channel management table 240.

LocalIPAddr 243 stores an IP address of the media gateway 100. LocalRtpPort 240 stores a port number of the media gateway 100, of which a counterunit terminal must be notified in order to receive an RTP Payload from the counterunit terminal. LocalRtcpPort 245 stores a port number of the media gateway 100, through which a realtime transport control protocol (RTCP) message is received.

RemoteIPAddr 246 stores an IP address of an IP terminal to which the media gateway 100 must send the RTP Payload. RemoteRtpPort 247 stores an RTP port number of a counterunit terminal. RemoteRtcpPort 248 stores an RTCP port number and NoTxPayloadType 249 stores the number of payload types that are available in the counterunit terminal. TxPayloadType 250 stores a payload type. The RTP channel management table 240 includes fields 251 to 255 that store jitter-related information. Referring to data stored in the RTP channel management table 240, the channel management unit 120 transmits/receives RTP data to/from a terminal of an IP-side VoIP user.

The connection management table 260 is a table that associates the TDM channel management table 200 with the RTP channel management table 240. In other words, the connection management table 260 combines the TDM channel management table 200 and the RTP channel management table 240 into a set by associating the channelID 202 of the TDM channel management table 200 and the ChannelID 241 of the RTP channel management table 260 with respect to one VoIP call.

In detail, ConnectionID 262 stores values that distinguish a VoIP call. Status 264 stores a connection status and DspID 266 stores values that identify DSPs in which connection is processed.

DspSessionID 268 is used to distinguish DSP local calls in the channel management unit 120. The DspSessionID 268 is used to store information on a TDM channel and an RTP channel with respect to one VoIP call in channel data units 152, 162, 172 and 182 of the DSPs 150, 160, 170 and 180.

In other words, the channel management unit 120 uses the DspSessionID 268 to distinguish VoIP channel information that is necessary in the DSP. The ConnectionID 262 is call connection management data at level of the entire media gateway 100. The DspSessionID 268 is local data that is used inside the DSPs 150, 160, 170 and 180.

Channel1 270 and Channel2 274 are channel identifiers associated with connection. Channel1Type 272 and Channel2Type 276 indicate channel types of the Channel1 270 and the Channel2 274, respectively.

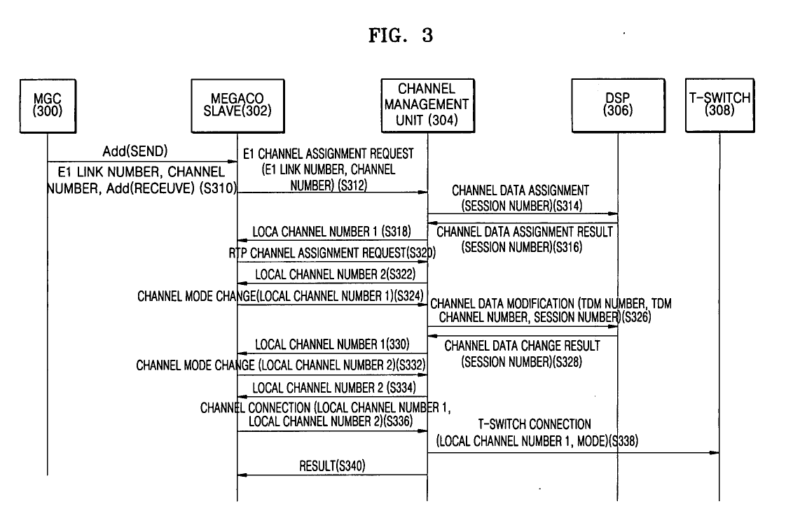

FIG. 3 is a flowchart illustrating a method of managing a local channel during call processing in the media gateway according to the present invention.

FIG. 3 shows a media gateway controller (MGC) 300, a MEGACO slave 302, a channel management unit 304, a DSP 306 and a T-switch 308.

The MEGACO slave 302 receives an add command of outgoing and incoming channel assurance from the MGC 300 (S310). The add command that instructs the outgoing channel assurance includes an E1 link number and a channel number. The MEGACO slave 302 sends E1 channel assignment request data to the channel management unit 120 (S312). Here, the E1 channel assignment request data includes the E1 link number and the channel number, which are contained in the received add command.

The E1 link is a trunk line that is physically connects the gateway and the PSTN exchange. In a case where one E1 link is divided into 32 time slots and transmits/receives electrical signals, the channel number indicates logical channels for the respective 32 time slots.

The channel management unit 304 assigns local channel numbers based on the E1 link number and the channel number contained in the channel assignment request data (for example, local channel number=(E1 line number −1)×number of data channels per link+channel number). Then, the channel management unit 304 assigns session numbers for the selected DSP (numbers for identifying calls that are used inside one DSP), and requests channel data assignment to the selected DSP (S314).

The DSP 306 that receives the channel data assignment request assigns memory with respect to the channel data, stores the session number in the assigned memory, and sends the assignment result to the channel management unit 304 (S316). The channel management unit 304 sends the assigned local channel number 1 to the MEGACO slave 302 (S318).

If the MEGACO slave 302 requests the assignment for the RTP channel (S320), the channel management unit 304 searches for a channel of idle status among channels regulated as available during initialization of the media gateway 100 and assigns the channel as the RTP channel. The channel management unit 304 sends the assignment result to the MEGACO slave (S322).

If the channel management unit 304 receives from the MEGACO block a change request of channel mode (Send_Only mode, Receive_Only mode, Send_Receive mode, etc.) for the local channel 1 that is the TDM channel (S324), the channel management unit 304 sends the TDM channel data change information (TDM number, TDM channel number, previously assigned session number) to the selected DSP 306 (S326). The DSP 304 changes the mode of the corresponding TDM channel and then sends the result to the channel management unit 304 (S328). Then, the channel management unit 304 sends the received result and the local channel number 1 to the MEGACO slave (S330).

If the channel management unit 304 receives from the MEGACO slave 302 the channel mode change request for the local channel 2 that is the RTP channel (S332), the channel management unit 304 changes the channel management data according to a call processing scenario and sends the result to the MEGACO slave 302 (S334). In FIG. 3, since the RTP channel is the incoming channel, the channel mode change request is a request for a change from Receive_Only mode to Send_Receive mode.

If the channel management unit 304 receives a request for connection of the assigned local channels 1 and 2 from the MEGACO slave 302, the channel management unit 304 performs an association of the two channels (local channels 1 and 2) through the connection management table 260 (S338). In other words, since the channel IDs and channel type information of the two channels are stored in the connection management table, information on the connection can be obtained by referring to only the associative management table. If necessary, the information on the respective channels can be obtained by searching the TDM (or RTP) channel management table alone. The channel management unit 304 connects the TDM and the E1 framer through the T-switch based on a status (e.g., one-way direction) of the TDM channel and then sends the result to the MEGACO slave (S340).

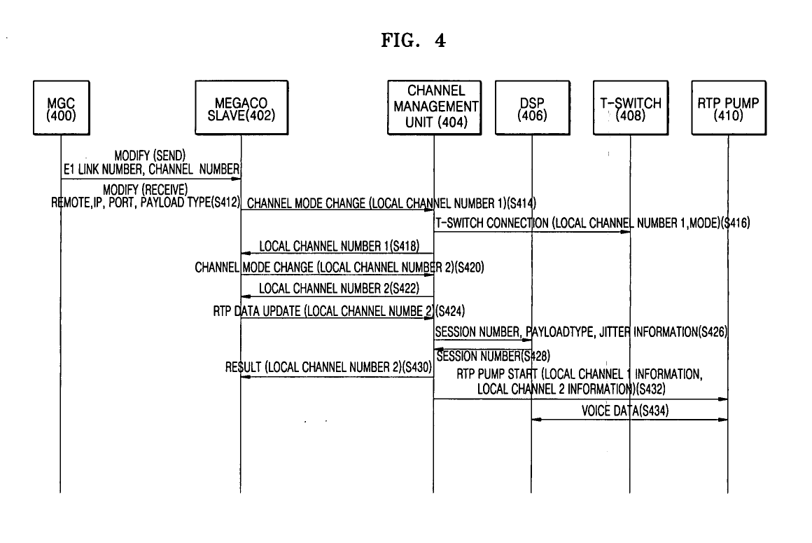

FIG. 4 is a flowchart illustrating a method of managing the local channel during call processing in the media gateway according to the present invention.

If the MEGACO slave 402 receives information on a remote channel from the MGC 400 through a modify message (S412), the MEGACO slave 402 requests a channel data modification to the channel management unit 404 (S414). If the local channel 1 that is the channel data modification target is a TDM channel (S414), the channel management unit 404 connects the TDM and the E1 framer through the T-switch based on a status (e.g., bi-direction) of the TDM channel (S416), and sends the result to the MEGACO slave 402 (S418). If data for the incoming channels is all received, the bidirectional connection is achieved.

If the local channel 2 that is the channel data modification target is an RTP channel (S420), the channel management unit 404 modifies the local channel management data (RemoteIPAddress, RemoteRtpPort, RemoteRtcpPort, TxPayloadType, Jitter information), and sends the result to the MEGACO slave 402 (S422).

If the channel management unit 404 receives an information update request (channel data modification request) for a remote terminal from the MEGACO slave 402, the channel management unit 404 sends data (PayloadType, Jitter information), necessary for DSP local voice information modification to the selected DSP 406 together with the session number (S426). The DSP 406 modifies the corresponding data and then sends the result to the channel management unit 404 (S428).

The channel management unit 404 sends the received result to the MEGACO slave 402 (S430). In a case where the status of the RTP channel data is bidirectional, if voice data transmission/reception for an RTP Payload is started (S432), voice data between the DSP 406 of the media gateway 100 and the RTP Pump 410 is transmitted to both terminals (S434).

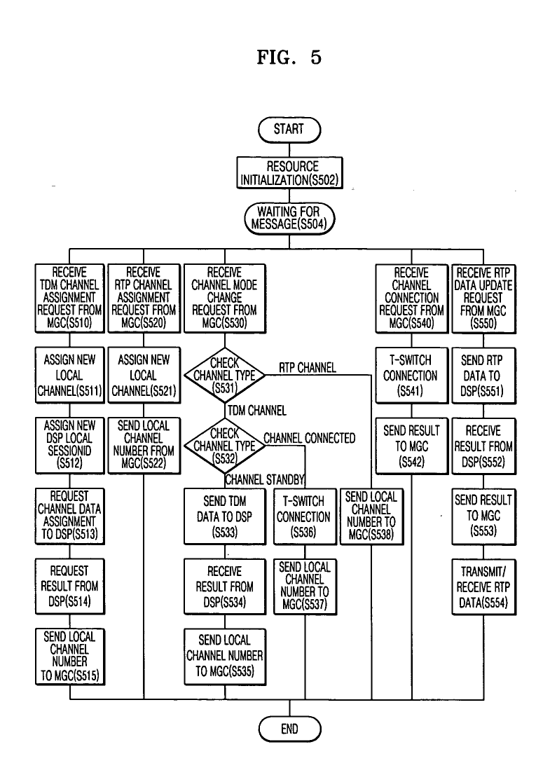

FIG. 5 is a flowchart illustrating a method of managing the channel in the media gateway according to the present invention.

Since a concept of channel disconnection is equal to that of channel connection, only channel connection will be described below. For simplicity, abnormal processing portions are omitted in the drawing.

If the channel management unit 120 starts, the channel management unit 120 initializes resources which need to be managed inside the channel and media gateway 100 (S502), and waits for messages from the MEGACO slave 130, the HI master 124 communicating with the DSPs 150, 160, 170 and 180, and the respective devices (S504).

If the TDM channel assignment request message is transmitted from the MEGACO slave 130 to the channel management unit 120 (S510), the channel management unit 120 assigns the local channel which is intended to be mapped to the external channel, among idle channels of the TDM channel, based on the received E1 link number and channel number (S511).

The channel management unit 120 assigns a DSP local SessionID for communication with the DSPs 150, 160, 170 and 180 (S512) and sends the channel data assignment request message to the DSP (S513). If the channel management unit 120 receives a response to the channel data assignment request from the DSP (S514), the channel management unit 120 sends its results, including the assigned local channel number, to the MEGACO slave 130 (S515).

If the RTP channel assignment request message is transmitted from the MEGACO slave 130 to the channel management unit 120 (S520), the channel management unit 120 assigns an idle channel (S521) and sends the assigned local channel number to the MEGACO slave 130 (S522).

If the channel mode change request with respect to the already assigned channel is transmitted from the MEGACO slave 130 to the channel management unit 120 (S530), the channel management unit 120 checks the type of the requested channel (S531).

If the channel type is an RTP channel (S531), the channel management unit 120 changes the channel status into the requested mode and sends the result to the MEGACO slave 130 (S538). The local channel number appointed between the MEGACO slave 130 and the channel management unit 120 is transmitted as the result.

If the channel type is a TDM channel (S531), the channel status is checked (S532). If the channel is in an already connected status, the channel management unit 120 connects the T-switch suitably for the channel status (S536) and sends the result to the MEGACO slave 130 (S537). The local channel number appointed between the MEGACO slave and the channel management unit is transmitted as the result.

If the channel status is in a channel standby status (S532), the channel management unit 120 sends TDM data to the DSP and receives the result (S534). The channel management unit 120 sends the received result to the MEGACO slave 130 using the local channel number (S535).

If the channel connection request message is transmitted from the MEGACO slave 130 to the channel management unit 120 (S540), the channel management unit 120 associates the two channels (local channels 1 and 2) through the associative management table 160 (S541). The channel management unit 120 connects the TDM and the E1 framer through the T-switch (S541) and sends the result to the MEGACO slave 130 (S542).

If the RTP data update request message is transmitted from the MEGACO slave 130 to the channel management unit 120 (S550), the channel management unit 120 sends the data (PayloadType, Jitter information) necessary for DSP internal voice information conversion to the selected DSP 406 together with the session number (S551).

The DSP modifies the corresponding data and sends the result to the channel management unit 120 (S552). The channel management unit 120 sends the received result to the MEGACO slave 130 (S553). If voice data transmission/reception for an RTP Payload is started, voice data between the internal DSP and the RTP pump is transmitted to both terminals (S554).

Since the media gateway of the present invention uses a centralized channel management method in call processing, the local DSPs of the media gateway can operate with only channel information necessary for the DSPs themselves without storing system-level channel information, and can provide channels for the requested E1 link in view of the outside of the system.

The present invention can also be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and carrier waves (such as data transmission over the Internet). The computer readable recording medium can also be distributed over network of coupled computer systems so that the computer readable code is stored and executed in a decentralized fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A media gateway, comprising:
a main control processor which selects one among a plurality of DSPs (digital signal processor) in response to a call setup request, selects a TDM (time division multiplexing) channel of the selected DSP, assigns a session number to the selected DSP in order to distinguish the call inside the selected DSP, and assigns a channel that is in an idle status among predetermined RTP (realtime transport protocol) available channels, as an RTP channel for the call;
a DSP unit to which the session number with respect to the TDM channel is assigned by the main control processor if the main control processor selects the TDM channel of the DSP among a plurality of DSPs each including a plurality of TDM channels, the DSP unit storing the session number; and
a T-switch which dynamically connects the plurality of TDM channels with a plurality of E1 links.

2. The media gateway of claim 1, wherein the main control processor comprises:
a MEGACO (media gateway control) slave which receives a predetermined control command from the media gateway controller, the predetermined control command including a call setup command; and
a control management unit which assigns the TDM channel and the RTP channel according to the call setup command.

3. The media gateway of claim 1, wherein the main control processor comprises a channel management data unit that comprises:
a first table which stores information on the TDM channel;
a second table which stores information on the RTP channel; and
a third table which stores connection information used to associate the RTP channel and the TDM channel.

4. The media gateway of claim 1, wherein the DSP comprises:
a channel data unit which stores the session number assigned by the main control processor;
a codec unit which converts voice data suitably for a PSTN (public switched telephone network) or an IP network based on information of a destination terminal that is connected to the IP network; and
a TDM which is connected to an E1 link of a PSTN.

5. A method of managing a channel in a media gateway, comprising:
selecting one among a plurality of DSPs in response to a call setup request, selecting a TDM channel of the selected DSP, and assigning a session number to the selected DSP in order to distinguish the call inside the selected DSP;
assigning a channel that is in an idle status among predetermined RTP available channels as an RTP channel for the call; and
connecting the assigned TDM channel and the assigned RTP channel.

6. The method of claim 5, further comprising:
changing modes of the TDM channel and the RTP channel in response to a channel mode change command.

7. The method of claim 6, wherein the channel mode includes a Send_Only mode, a Recevie_Only mode, and a Send_Receive mode.

8. The method of claim 5, wherein the connecting the channels includes connecting the selected TDM channel and an external E1 link.

9. The method of claim 5, further comprising:
storing information on the selected TDM channel in a first table;
storing information on the selected RTP channel in a second table; and
storing connection information in a third table, the connection information being used to associate the TDM channel and the RTP channel.

10. The method of claim 9, wherein the connecting the channels includes associating the TDM channel and the RTP channel by storing the channel information of the first table and the channel information of the second table in the third table.

11. The method of claim 5, further comprising:
receiving information on a destination terminal that is connected to an IP network; and
sending the information on the destination terminal to the selected DSP and converting voice data suitably for the destination terminal or a PSTN.
